(19) United States
(12) Patent Application Publication
(10) Pub. No.: US 2014/0213185 A1
(43) Pub. Date: Jul. 31, 2014

(54) METHODS, APPARATUSES AND COMPUTER PROGRAM PRODUCTS FOR PERFORMING WIRELESS INNERCOPY OF DATA BETWEEN DEVICES

(71) Applicants: Jarmo Arponen, Espoo (FI); Harald Kaaja, Jarvenpaa (FI); Joni Jantunen, Helsinki (FI)

(72) Inventors: Jarmo Arponen, Espoo (FI); Harald Kaaja, Jarvenpaa (FI); Joni Jantunen, Helsinki (FI)

(73) Assignee: Nokia Corporation, Espoo (FI)

(21) Appl. No.: 14/342,344

(22) PCT Filed: Sep. 7, 2011
(86) PCT No.: PCT/FI2011/050767

§ 371 Date: Feb. 28, 2014

(51) Int. Cl. H04B 5/00

(52) U.S. Cl. CPC H04B 5/0031
USPC 455/41.1

(57) ABSTRACT

An apparatus facilitating a direct memory copy among devices may include a processor and memory storing executable computer code causing the apparatus to at least perform operations including exchanging content with a device via a near field communication responsive to entering a proximity of the device. The computer program code causes the apparatus to detect an item(s) of data of a block(s) of local memory for remote access and negotiate, via communications across a first interface, with the device to determine whether the device desires receipt of the item(s). The computer program code causes the apparatus to provide, via a second interface, the item(s) of data to the device, within the proximity, responsive to a received indication from the device requesting the item(s) to enable the device to store the item(s) of data in an agreed upon block(s) of remote memory. Corresponding methods and computer program products are also provided.

### TECHNOLOGICAL FIELD

An example embodiment of the present invention relates generally to wireless communication technology and more particularly, relates to an apparatus, a method and a computer program product for enabling dynamic device detection and selection of content for transfer between devices.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer relates to services for transferring large amounts of data between communication devices.

For instance, currently, transferring large amounts of data between communication devices via Near Field Communication (NFC) is quite common. For instance, close proximity between the memories of communication devices is typically required for the exchange of data across very short distances via near field communication and the nature of this data exchange generally occurs in a fast and adhoc manner. Given the fast and adhoc manner of the data exchange, data of interest typically needs to be located fast so that when it is identified, a communication device may retrieve the data and transfer it to a memory of another communication device.

However, a problem may arise in an instance in which communication devices desire to transfer large amounts of content between memories of each other. For instance, communication devices implementing Near Field Communication may utilize data interfaces for transferring large data files, which may require multiple different bit rates to facilitate the transfer. However, currently NFC technology is typically limited with respect to the bit rate and the capacity (e.g., kilobits/sec, one or more megabits (Mbits) in tags. For example, these multiple different bit rates may be utilized to perform one task serially such as, for example, selecting a proper data interface for the transfer of the data files. This means the communication devices may need to change from one low bit rate to a high bit rate and vice versa in a fast manner to facilitate the transfer of the data via a Near Field Communication. For instance, in an instance in which a “high speed” NFC exists, the change from a low bit rate to a high bit rate may occur within the NFC. On the other hand, in an instance in which a low to high-speed occurs from a NFC to alternate high speed carriers, such change may be performed with a NFC handover.

Although existing communication devices utilizing NFC are typically capable of implementing static handover to facilitate change from one low bit rate to a high bit rate, such as for example, to current high speed carriers, such as Wireless Local Area Network (WLAN), and Bluetooth (BT), the communication devices may be unable to activate an alternative carrier circuit during an existing handover process to facilitate the data transfer to a memory of another communication. As such, the data transfer may fail and/or bottlenecks in the data transfer may occur which may result in dissatisfaction to a device user.

In view of the foregoing drawbacks, it may be beneficial to provide a more efficient and reliable mechanism of transferring data between memories of devices within a close proximity.

### BRIEF SUMMARY

A method, apparatus and computer program product are therefore provided that may enable an efficient and reliable manner for facilitating a direct memory copy of data among devices. An example embodiment of the invention may organize one or more items of content of one or more memory blocks of a local memory such as, for example, of a RF memory tag (also referred to herein as an embedded tag (for example, an embedded tag of a device)) for direct transfer to one or more other remote memories of devices (e.g., tags of communication devices). In this regard, an example embodiment may provide wirelessly bonded lines between at least two memories.

An example embodiment may facilitate negotiation of the transfer of at least one of the items of content via a fast Wireless Data Interface (WDI) such as, for example, an 8 GHz WDI. The negotiation information may include control memory data, as well as any other suitable data, for facilitating the negotiation among devices for the transfer of the content. For example, a negotiation for a direct memory copy may include part of the memory content for a copy, an entire one-to-one memory copy, and/or a memory erasing negotiation. In an example embodiment, the memory erasing negotiation may relate to an instance of a direct memory erase which may be opposite to a direct memory copy. Additionally, an example embodiment may facilitate the transfer of at least one of the items of content to a remote memory via a dedicated WDI (e.g., a 60 GHz WDI). In this regard, by streamlining some negotiations for transfer of items of content of memory blocks that are available for remote access via a first interface (e.g., a WDI (e.g., a 8 GHz WDI)) and facilitating the actual transfer of the negotiated data via a dedicated second interface (e.g., a WDI (e.g., a 60 GHz WDI)) an example embodiment may enable selection of large amounts of data for transfer from one memory device directly to one or more other memory devices in a short period of time. As such, an example embodiment may minimize bottlenecks and data management traffic associated with transfer of data among devices.

In one example embodiment, a method of facilitating a direct memory copy among devices is provided. The method may include exchanging content with at least one device via a near field communication in response to entering a proximity of the device and detecting one or more items of data of one or more corresponding memory blocks or areas of local memory. The memory blocks or areas of local memory are available for remote access. The method may also include negotiating, via one or more communications across a first interface, with the at least one device to determine whether the device desires receipt of at least one of the items of data. The method may also include enabling provision, via a second interface, of the at least one item of data to the device. The at least one item of data may be provisioned, via the second interface, to the device, while within the proximity of the device, in response to receipt of an indication from the device requesting the item of data in order to enable the device to store the item of data in one or more agreed upon memory blocks or areas of remote memory.

In another exemplary embodiment, an apparatus for facilitating a direct memory copy among devices is provided. The apparatus may include a processor and memory including computer program code. The memory and the computer program code are configured to, with the processor, cause the apparatus to at least perform operations including exchanging content with at least one device via a near field communication in response to entering a proximity of the device and detecting one or more items of data of one or more corresponding memory blocks or areas of local memory. The memory blocks or areas of local memory are available for remote access. The computer program code may further cause the apparatus to negotiate, via one or more communications across a first interface, with the at least one device to determine whether the device desires receipt of at least one of the items of data. The computer program code may further cause the apparatus to enable provision, via a second interface, of the at least one item of data to the device. The at least one item of data may be provisioned to the device, via the second interface, while within the proximity of the device, in response to receipt of an indication from the device requesting the item of data in order to enable the device to store the item of data in one or more agreed upon memory blocks or areas of remote memory.

In another exemplary embodiment, a computer program product for facilitating a direct memory copy among devices is provided. The computer program product includes at least one computer-readable storage medium having computer-executable program code portions stored therein. The computer-executable program code instructions may include program code instructions configured to exchange content with at least one device via a near field communication in response to entering a proximity of the device and detecting one or more items of data of one or more corresponding memory blocks or areas of local memory. The memory blocks or areas of local memory are available for remote access. The program code instructions may also negotiate, via one or more communications across a first interface, with the at least one device to determine whether the device desires receipt of at least one of the items of data. The program code instructions may also enable provision, via a second interface, of the at least one item of data to the device. The at least one item of data may be provisioned, via the second interface, while within the proximity of the device, in response to receipt of an indication from the device requesting the item of data in order to enable the device to store the item of data in one or more agreed upon memory blocks or areas of remote memory.

In another example embodiment, an apparatus for facilitating a direct memory copy among devices is provided. The apparatus may include means for exchanging content with at least one device via a near field communication in response to entering a proximity of the device and means for detecting one or more items of data of one or more corresponding memory blocks or areas of local memory. The memory blocks or areas of local memory are available for remote access. The apparatus may also include means for negotiating, via one or more communications across a first interface, with the at least one device to determine whether the device desires receipt of at least one of the items of data. The apparatus may also include means for enabling provision, via a second interface, of the at least one item of data to the device. The at least one item of data may be provisioned, via the second interface, while within the proximity of the device, in response to receipt of an indication from the device requesting the item of data in order to enable the device to store the item of data in one or more agreed upon memory blocks or areas of remote memory.

An example embodiment of the invention may provide a better user experience since a communication device may more efficiently and reliably facilitate transfer of data to memory of devices. As a result, the communication device may conserve resources and may perform in an improved manner.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an example embodiment of the invention;

FIG. 2A is a schematic block diagram of an apparatus according to an example embodiment of the invention;

FIGS. 2B and 2C are schematic block diagrams of an apparatus according to another example embodiment of the invention;

FIG. 3 is a schematic block diagram of a system for enabling a direct memory copy among devices according to an example embodiment of the invention;

FIG. 4 is a schematic block diagram of a system for enabling controllers of devices to determine data of blocks of memory available for direct memory copy according to an example embodiment of the invention;

FIG. 5 is a schematic block diagram of another system for enabling a direct memory copy among devices according to an example embodiment of the invention;

FIG. 6 is a schematic block diagram of another system for enabling a direct memory copy among devices according to an example embodiment of the invention;

FIG. 7 is a schematic block diagram of another system for enabling a direct memory copy among devices according to an example embodiment of the invention;

FIG. 8 is a schematic block diagram for chaining one or more controllers and memories of devices according to an example embodiment of the invention;

FIG. 9 is a schematic block diagram of a system for enabling transfer of parameters among devices facilitating a direct memory copy according to an example embodiment of the invention;

FIG. 10 is a schematic block diagram of a system for enabling transfer of other parameters among devices facilitating a direct memory copy according to an example embodiment of the invention; and

FIG. 11 illustrates a flowchart for enabling a direct memory copy among devices according to an example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

As referred to herein, a direct memory copy (also referred to herein as wireless innercopy) may be a copy or transfer of one or more items of data of a memory block(s), area(s), section(s) or the entire memory content, or the like of memory from one device to another device. In some example embodiments, the connectivity and control operations associated with the transfer of the items of data from one device to one or more other devices may be facilitated, based in part, by a first interface and the actual transfer of the items of data may be facilitated, based in part, by a second interface.

Additionally, some example embodiments may facilitate operation of one or more wireless innercopies between the memory management platforms of two or more devices. In this regard, an example embodiment may create one or more wireless bonding lines between two or more memories (e.g., memories of chips (e.g., RF memory tags)), integrating these memories, or memory areas that are partially integrated, which may be overlapping during wireless bonding. Additionally, as referred to herein low level memory access may denote a lowest level of memory access, which may be utilized for a direct memory copy, to read and/or write content to one or more corresponding areas or block of memory.

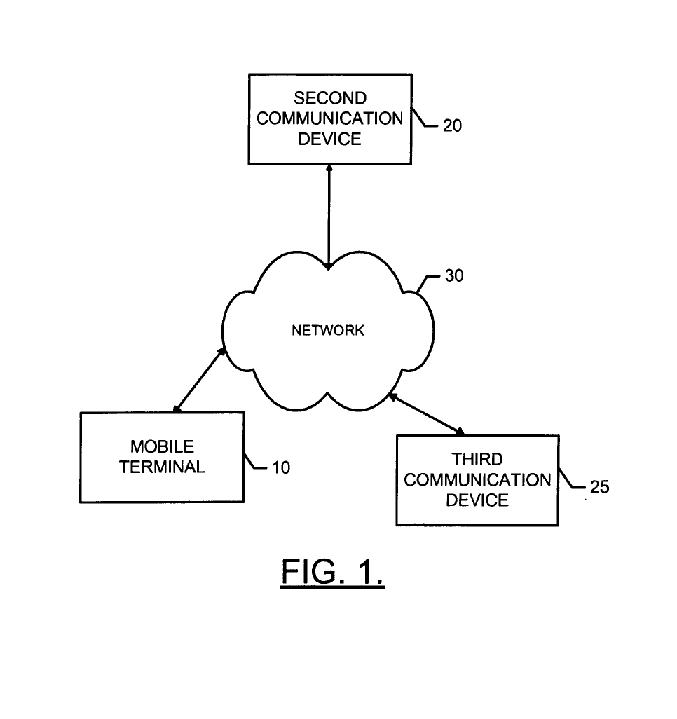

FIG. 1 illustrates a generic system diagram in which a device such as a mobile terminal 10 is shown in a communication environment according to some example embodiments. As shown in FIG. 1, a system in accordance with some example embodiments may include a first communication device (for example, mobile terminal 10) and a second communication device 20 capable of communication with each other via a network 30. In some cases, embodiments of the present invention may further include one or more additional communication devices, one of which is depicted in FIG. 1 as a third communication device 25. In some embodiments, not all systems that employ an embodiment of the present invention may comprise all the devices illustrated and/or described herein. While example embodiments of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) and/or Global Navigation Satellite System (GLONASS) devices, Bluetooth headsets, Universal Serial Bus (USB) devices or any combination of the aforementioned, and other types of voice and text communications systems, can readily employ embodiments of the present invention. Furthermore, devices that are not mobile, such as servers and personal computers may also readily employ embodiments of the present invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all-inclusive or detailed view of the system or the network 30. According to some example embodiments the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE) or Evolved Universal Terrestrial Radio Access Network (E-UTRAN), Self Optimizing/Organizing Network (SON) intra-LTE, inter-Radio Access Technology (RAT) Network and/or the like. According to some example embodiments, the network 30 may be a point-to-point (P2P) network (e.g., a close proximity network).

One or more communication terminals such as the mobile terminal 10 and the second and third communication devices 20 and 25 may be in communication with each other via the network 30 and each may include an antenna or antennas for transmitting signals to and for receiving signals from one or more base sites. The base sites could be, for example one or more base stations (BSs) that is a part of one or more cellular or mobile networks or one or more access points (APs) that may be coupled to a data network, such as a Local Area Network (LAN), Wireless Local Area Network (WLAN), a Wi-Fi Network, a Metropolitan Area Network (MAN), and/or a Wide Area Network (WAN), such as the Internet. In turn, other devices such as processing elements (for example, personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other. For example, the mobile terminal 10 and the second and third communication devices 20 and 25 as well as other devices may communicate according to numerous communication protocols including Hypertext Transfer Protocol (HTTP) and/or the like, to thereby carry out various communication or other functions of the mobile terminal 10 and the second and third communication devices 20 and 25, respectively.

Furthermore the mobile terminal 10 and the second and third communication devices 20 and 25 may communicate in accordance with, for example, Universal Serial Bus (USB), Radio Frequency (RF), Cellular, Near Field Communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (Wi-Fi), Ultra-Wide Band (UWB), Wibree, Bluetooth Low Energy (LE) techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet, RF over fiber and/or the like.

According to some example embodiments, the first communication device (for example, the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be servers, remote computers or terminals such as personal computers (PCs) or laptop computers.

According to some example embodiments, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities.

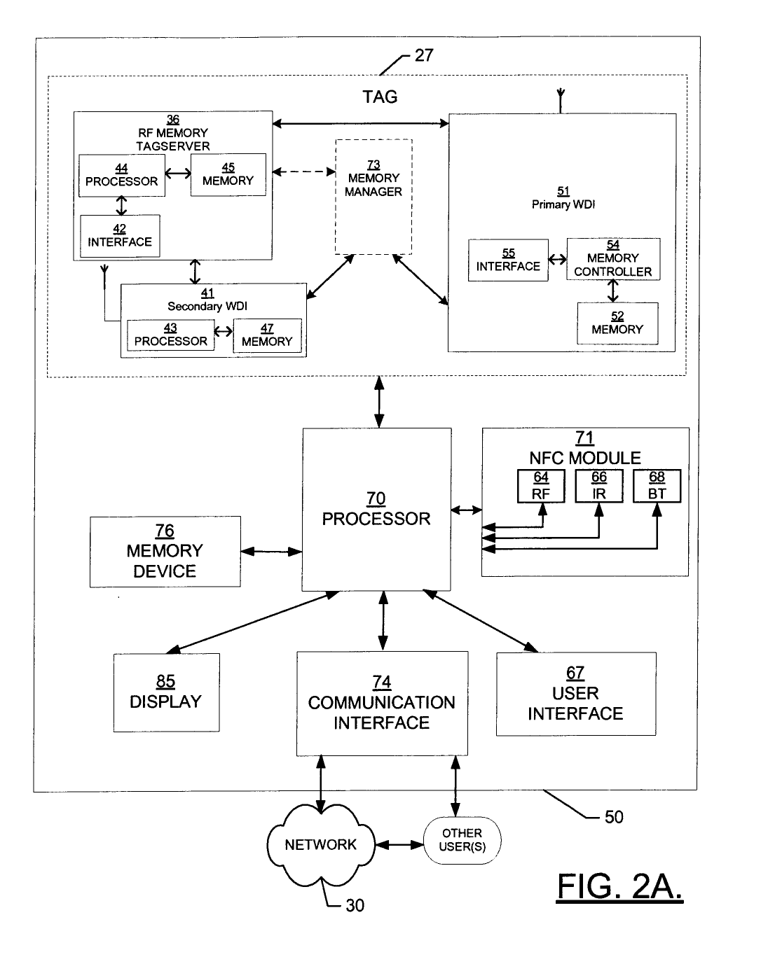

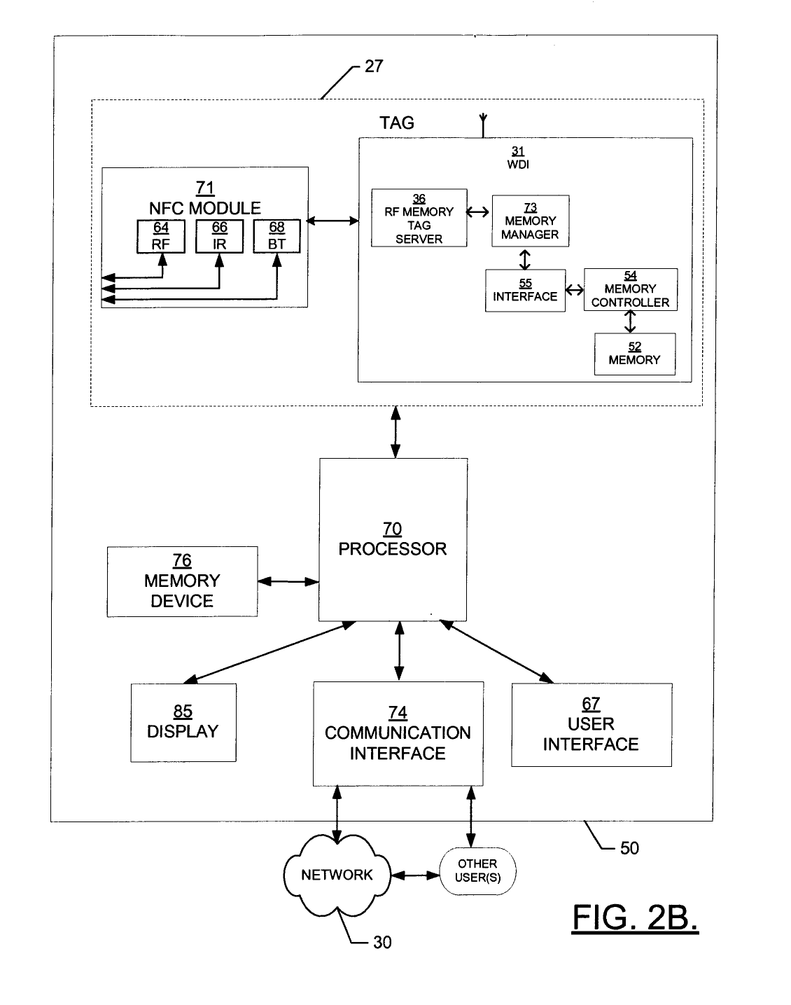

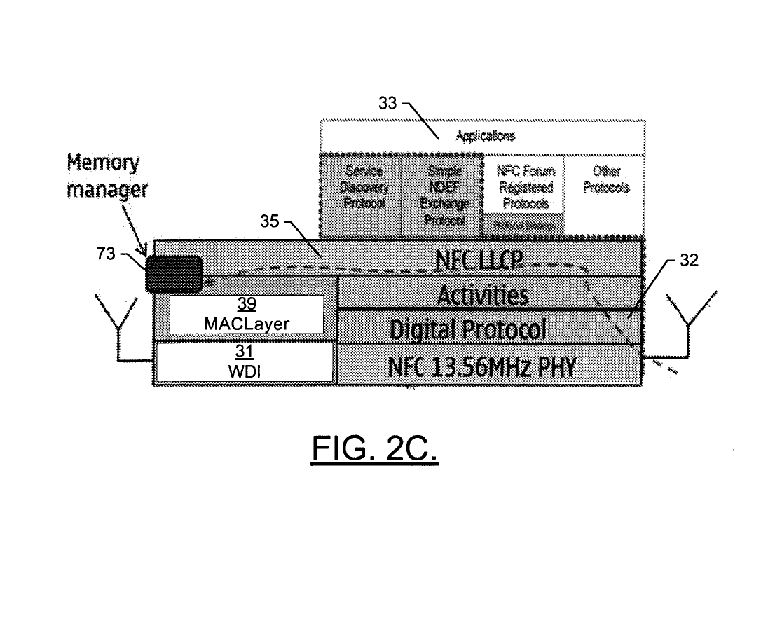

According to some example embodiments, the mobile terminal as well as the second and third communication devices 20 and 25 may employ an apparatus (for example, the apparatus 50 of FIG. 2A) capable of functioning according to example embodiments of the invention. In some example embodiments, the second and third communication devices 20 and 25 may, but need not, be client devices. The communication devices 20 and 25 may request data from the mobile terminal 10 and/or from each other.

FIG. 2A illustrates a schematic block diagram of an apparatus for enabling direct memory copy of data between devices according to some example embodiments. Some example embodiments of the invention will now be described with reference to FIG. 2A, in which certain elements of an apparatus 50 are displayed. The apparatus 50 of FIG. 2A may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, an embodiment may be employed on a combination of devices. Accordingly, some embodiments of the invention may be embodied wholly at a single device (for example, the mobile terminal 10), by a plurality of devices in a distributed fashion (for example, on one or a plurality of devices in a P2P network) or by devices in a client/server relationship. Furthermore, it should be noted that the devices or elements described below may not be mandatory and thus some may be omitted in some embodiments.

Referring now to FIG. 2A, the apparatus 50 may include or otherwise be in communication with a processor 70, a user interface 67, a communication interface 74, a memory device 76, a display 85 and a Near Field Communication (NFC) module 71. The apparatus 50 may also include a tag 27 (also referred to herein as transponder 27) (e.g., a NFC tag, a Radio Frequency Identification (RFID) tag, a RF memory tag, a BT chip and/or the like). Optionally, the tag 27 may be an embedded tag within the apparatus 50. In another alternative example embodiment, the tag 27 may be external to the apparatus 50. The tag 27 may include a primary Wireless Data Interface (WDI) 51 (also referred to herein as primary interface 51) (e.g., an 8 GHz WDI), a memory manager 73, a RF memory tag server 36, and a secondary WDI 41 (also referred to herein as secondary interface 41) (e.g., a 60 GHz WDI). The RF memory tag server 36 may include a processor 44, a memory 45 and an interface 42. Although FIG. 2A shows a primary WDI 51 and a secondary WDI 41, it should be pointed out that the apparatus 50 may include any suitable number of WDIs without departing from the spirit and scope of the invention.

According to some example embodiments, the display 85 may be a touch screen display. The memory device 76 may include, for example, volatile and/or non-volatile memory. For example, the memory device 76 may be an electronic storage device (for example, a computer readable storage medium) comprising gates configured to store data (for example, bits) that may be retrievable by a machine (for example, a computing device like processor 70). In some example embodiments, the memory device 76 may be a tangible memory device that is not transitory. The memory device 76 may be configured to store information, data, files, applications (e.g., Web applications, etc.), instructions or the like for enabling the apparatus 50 to carry out various functions in accordance with example embodiments of the invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content (for example, pictures, videos, images, etc.).

The apparatus 50 may, according to some example embodiments, be a mobile terminal (for example, mobile terminal 10) or a fixed communication device or computing device configured to employ example embodiments of the invention. According to some example embodiments, the apparatus 50 may be embodied as a chip or chip set. In other words, the apparatus 50 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. The apparatus 50 may therefore, in some cases, be configured to implement embodiments of the invention on a single chip or as a single “system on a chip.” As such, in some cases, a chip or chipset may constitute means for performing one or more operations for providing the functionalities described herein. Additionally or alternatively, the chip or chipset may constitute means for enabling user interface navigation with respect to the functionalities and/or services described herein.

The processor 70 may be embodied in a number of different ways. For example, the processor 70 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In some example embodiments, the processor 70 may be configured to execute instructions stored in the memory device 76 or otherwise accessible to the processor 70. As such, whether configured by hardware or software methods, or by a combination thereof, the processor 70 may represent an entity (for example, physically embodied in circuitry) capable of performing operations according to embodiments of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and operations described herein when the instructions are executed. However, in some cases, the processor 70 may be a processor of a specific device (for example, a mobile terminal or network device) adapted for employing embodiments of the invention by further configuration of the processor 70 by instructions for performing the algorithms and operations described herein. The processor 70 may include, among other things, a clock, an arithmetic logic unit (ALU) and logic gates configured to support operation of the processor 70.

In some example embodiments, the processor 70 may be configured to operate a connectivity program, such as a browser (e.g., Web browser) or the like. In this regard, the connectivity program may enable the apparatus 50 to transmit and receive Web content, such as for example location-based content or any other suitable content (e.g., applications), according to a Wireless Application Protocol (WAP), for example. It should be pointed out that the processor 70 may also be in communication with the display 85 and may instruct the display to illustrate any suitable information, data, content (e.g., media content) or the like.

The communication interface 74 may be any means such as a device or circuitry embodied in either hardware, a computer program product, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, a joystick, a display, a touch screen, a microphone, a speaker, or other input/output mechanisms. In some example embodiments in which the apparatus is embodied as a server or some other network devices, the user interface 67 may be limited, remotely located, or eliminated. The processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (for example, software and/or firmware) stored on a memory accessible to the processor 70 (for example, memory device 76, and/or the like).

As shown in FIG. 2A, the apparatus 50 may also include one or more means for sharing and/or obtaining data. For example, the apparatus 50 may comprise a NFC module 71 that includes a short range radio frequency (RF) transceiver and/or interrogator 64 so data may be shared with and/or obtained from electronic devices in accordance with RF techniques. The apparatus 50 may comprise other short range transceivers, such as, for example an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be configured to operate according to Wibree™, BT LE radio standards. In this regard, the apparatus 50 and, in particular, the NFC module 71 may be capable of transmitting data to and/or receiving data from electronic devices (e.g., other apparatuses 50, tags, transponders, etc.) within a proximity of the apparatus 50 such as, for example, within 10 centimeters. However, the NFC module 71 may be capable of transmitting data to and/or receiving data from electronic devices within other suitable proximities. Although not shown, the apparatus may be configured to transmit and/or receive data from electronic devices according various wireless networking techniques, including Wireless Fidelity (Wi-Fi), WLAN techniques such as IEEE 802.11 techniques, and/or the like. In some example embodiments, the NFC module 71 may be operating at an NFC frequency (e.g., 13.56 MHz) or an Ultra High Frequency (UHF) (e.g., at 900 MHz). The NFC frequency (e.g., 13.56 MHz) and/or the UHF (e.g., 900 MHz) may be utilized, by the NFC module 71, to provide one or more Wireless Power Transfers (WPTs). In this regard, the NFC module 71 may facilitate NFC data transfers (e.g., small amounts of data from/to one or more NFC tags) and may also facilitate data transfer to the primary WDI 51 and/or the secondary WDI 41. Additionally, it should be pointed out that in an example embodiment, the interrogator 64, the IR transceiver 66 and the BT transceiver 68 may each include an NFC reader (not shown) that is capable of reading and receiving a short-range communication or Near Field Communication upon interrogation by the NFC reader.

In an example embodiment, the NFC module 71 may interrogate and communicate data with a device (e.g., another tag 27 of an apparatus 50) in an instance in which the apparatus 50 enters a proximity of the device. In this regard, when the NFC module 71 detects that it is within the proximity of the device (e.g., another apparatus 50), the NFC module 71 may wakeup and may provide a continuous wave (CW) signal indicating a clock reference of the apparatus 50 to the other device (e.g., an NFC module of another apparatus 50) during an interrogation phase. In response to completion of the interrogation phase, the NFC module 71 may provide an indication to an interface (e.g., primary WDI 51) that the interrogation phase is complete. Upon receipt of the indication from the NFC module 71 that the interrogation phase is complete, the interface (e.g., primary WDI 51) may facilitate negotiations for transfer of memory to the device (e.g., another apparatus 50), as described more fully below.

The primary WDI 51 may be any means such as a device or circuitry embodied in either hardware, a computer program product, or a combination of hardware and software that is configured to receive and/or transmit data from/to any other primary WDI 51 (e.g., 8 GHz WDI) of another device (e.g., another apparatus 50) in communication with the apparatus 50. In this regard, the primary WDI 51 may include, for example, an antenna (or multiple antennas) and supporting hardware and/or software for enabling communications with devices. Additionally, the primary WDI 51 may include a memory controller 54, an interface 55 and a memory 52. The interface 55 may be any means such as a device or circuitry embodied in either hardware, a computer program product, or a combination of hardware and software that is configured to receive and/or transmit data from/to the primary WDI 51. The primary WDI 51 may communicate with other electronic devices according to RF, BT, IR or any other suitable short range or near field communication techniques. The primary WDI 51 may communicate with apparatuses (e.g., tags 27 of respective apparatuses 50) when the primary WDI 51 is within a proximity, range or distance of the apparatuses. In this regard, the primary WDI 51 may send one or interrogation signals to a respective apparatus 50 when the apparatus 50 is within the proximity of another apparatus 50. The interrogation signals may excite or trigger the apparatuses 50 to read data (e.g., RF/NFC data signals (e.g., data transfer signals)) from a tag (e.g., a tag 27) of an apparatus.

The memory controller 54 may be a processor, coprocessor, controller, microprocessor or other processing element including integrated circuits (e.g., embodied as an ASIC or FPGA) or circuitry configured to execute instructions, which may be stored in the memory 52, or perform other logical functions or corresponding portions described herein. For example, the memory controller 54 may determine whether one or more blocks of memory that are available for remote access and/or for transferring of data stored in the blocks to other devices (e.g., tags 27 of other apparatuses) upon entering a proximity of the other devices. The memory controller 54 may facilitate communication of data via a Near Field Communication when the apparatus 50 is within the proximity of the other devices.

In an example embodiment, the memory controller 54 of the primary WDI 51 may perform a data transfer negotiation with another device (e.g., another apparatus 50) that is detected within a proximity of the apparatus 50, as described more fully below. For instance, the primary WDI 51 may negotiate with the detected device for direct transfer of data of the apparatus 50 to the other device. The memory controller 54 may facilitate storage of the negotiation information in the memory 52. Upon completion of the data transfer negotiation, the memory controller 54 of the primary WDI 51 may also provide an indication of the completion of the data transfer negotiation to the RF memory tag server 36 via the interface 55.

The RF memory tag server 36 may include a processor 44, a memory 45, and an interface 42. The interface 42 may be an interface for communicating with the primary WDI 51, the memory manager 73 and the secondary WDI 41 as well as any other device or network, as described more fully below. The memory 45 may store the data transfer negotiation information provided to the RF memory tag server 36 by the primary WDI 51 as well as any other suitable information. In some example embodiments, the processor 70 may be embodied as, or otherwise control the processor 44 of the RF memory tag server 36. The processor 44 may be any means such as a device or circuitry operating in accordance with software or otherwise embodied in hardware or a combination of hardware and software (for example, processor 70 operating under software control). In some other example embodiments, the processor 44 may be a coprocessor, controller, microprocessor or other processing element including integrated circuits (for example, embodied as an ASIC or FPGA) or circuitry configured to execute instructions, which may be stored in the memory 45, or perform other logical functions or corresponding operations described herein.

The processor 44 of the RF memory tag server 36 may negotiate with a device (e.g., a RF memory tag server of another apparatus 50) to determine at which frequency (e.g., 60 GHz) one or more areas (also referred to herein as memory blocks) of memory of the apparatus 50 may be available for remote access by another device (e.g., another apparatus 50). Additionally, the processor 44 of the RF memory tag server may facilitate a direct memory copy or transfer of data via the secondary WDI 41 (e.g., a 60 GHz WDI) to a device (e.g., a tag 27 of another apparatus 50) that the primary WDI 51 previously negotiated with for transfer of the data.

The memory manager 73 may be any means such as a device or circuitry operating in accordance with software or otherwise embodied in hardware or a combination of hardware and software (for example, processor 70 operating under software control). In some other example embodiments, the memory manager 73 may be a processor, coprocessor, controller, microprocessor or other processing element including integrated circuits (for example, embodied as an ASIC or FPGA) or circuitry configured to execute instructions, which may be stored in a memory (e.g., memory device 76), or perform other logical functions or corresponding operations described herein. Optionally, the memory manager 73 may be a standalone device, in some example embodiments. In some alternative example embodiments, the memory manager 73 may optionally be included within the RF memory tag server 36. The memory manager 73 may be part of a memory management infrastructure and may facilitate the performance of one or more memory management functions. In one example embodiment, the memory manager 73 may communicate negotiation information to the RF memory tag server 36. The negotiation information communicated to the RF memory tag server 36 by the memory manager 73 may be received by the memory manager 73 from the primary WDI 51. The memory manager 73 may manage the buffering, memory handling and may provide information to one or more memory controllers (e.g., memory controller 54, memory controller 43) corresponding to the allocation and/or de-allocation of one or more blocks or areas of memory. Additionally, the memory manager 73 may execute one or more commands received from the RF memory tag server 36.

The secondary WDI 41 may communicate with other electronic devices according to RF, BT, IR or any other suitable short range or Near Field Communication techniques. The secondary WDI 41 may communicate with apparatuses (e.g., respective tags 27 of apparatuses 50) when an apparatus 50 is within a given proximity, range or distance of the apparatuses. In this regard, the secondary WDI 41 may send data of identified memory blocks (for example, of the memory 47) to another apparatus 50 (e.g., a tag 27 of the apparatus 50) when the apparatus 50 is within a proximity of the apparatus and in response to receipt of an indication from the primary WDI 51 and/or the RF memory tag server 36 that the transfer of data has been negotiated with the other apparatus 50.

The secondary WDI 41 may include a processor 43 (also referred to herein as memory controller 43). The processor 43 may be a coprocessor, controller, microprocessor or other processing element including integrated circuits (e.g., embodied as an ASIC or FPGA) or circuitry configured to execute instructions, which may be stored in memory or perform other logical functions or corresponding operations of the primary WDI 41 described herein. The processor 43 of the secondary WDI 41 may facilitate the direct memory copy of the data by providing the data to another device (e.g., a tag 27 of another apparatus 50) based in part on analyzing the data transfer negotiation information which may be stored in the memory 45 or by being provided the data transfer negotiation information from the processor 44 of the RF memory tag server 36. The data for transfer (also referred to herein as direct memory copy) may be obtained from the memory 47 by the processor 43 and may be provided, by the processor 43 of the secondary WDI 41, to a memory (e.g., a non-volatile memory of another tag 27) of another apparatus 50 that the primary WDI 41 and/or the RF memory tag server 36 negotiated with for transfer of data, as described more fully below. In order to enable the secondary WDI 41 to access the area(s) of the memory 47 of the secondary WDI 41 negotiated for transfer of the data by the primary WDI 41, the processor 44 of the RF memory tag server 36 may provide one or more tokens to the secondary WDI 41. The token(s) may indicate and may authorize access to the area(s) (e.g., one or more blocks) of the memory 47 by secondary WDI 41 for transfer of the data in the area(s) of memory 47 to a memory of another device (e.g., a memory of another tag 27 of another apparatus 50) negotiated with by the primary WDI 51 and/or by the RF memory tag server 36. The memory 47 may be non-volatile memory or any other suitable memory. In an alternative example embodiment, the memories 45, 47 and 52 may be a single memory. In another alternative example embodiment, a single memory device may include the memories 45, 47 and 52.

FIGS. 2B and 2C illustrate schematic block diagrams of an apparatus for enabling direct memory copy of data between devices according to some alternative example embodiments. In the example embodiment of FIG. 2B, a protocol stack 29 enable the NFC module 71 and the WDI 31 (e.g., primary WDI 51 (e.g., an 8 GHz WDI)) to be combined or integrated in order to minimize processor (e.g., processor 70) involvement in implementing a direct copy of one or more blocks or areas of memory between devices. In this example embodiment, the NFC module 71 may be a primary interface and the WDI 31 may be a secondary interface. The memory manager 73 may integrate low layers of an NFC stack 29 to minimize the host processor (e.g., processor 70) involvement with facilitating a direct memory copy between devices.

By utilizing an NFC communication protocol 32, one or more messages related to memory management may be implemented by the memory manager 73 instead of transferring all of the messages between one or more higher layers (e.g., one or more applications being executed by a processor(s) (e.g., processor 70). By combining the NFC module 71 and the WDI 31, the memory manager 73 may generate one or more memory management messages to be transferred over a NFC link 35 (also referred to herein as NFC Logical Link Control Protocol (LLCP) 35) that may be routed directly to a RF memory tag MAC layer 39 (or another memory manager). The memory manager 73 may be integrated directly on top of (or parallel with) the RF memory tag server MAC layer 39, with a bridge to a NFC stack. As a result, one or more notifications may be forwarded to upper layers (e.g., to a processor (e.g., a processor 70)) whereas the memory manager 73 may handle the direct memory copy between devices (e.g., apparatuses 50).

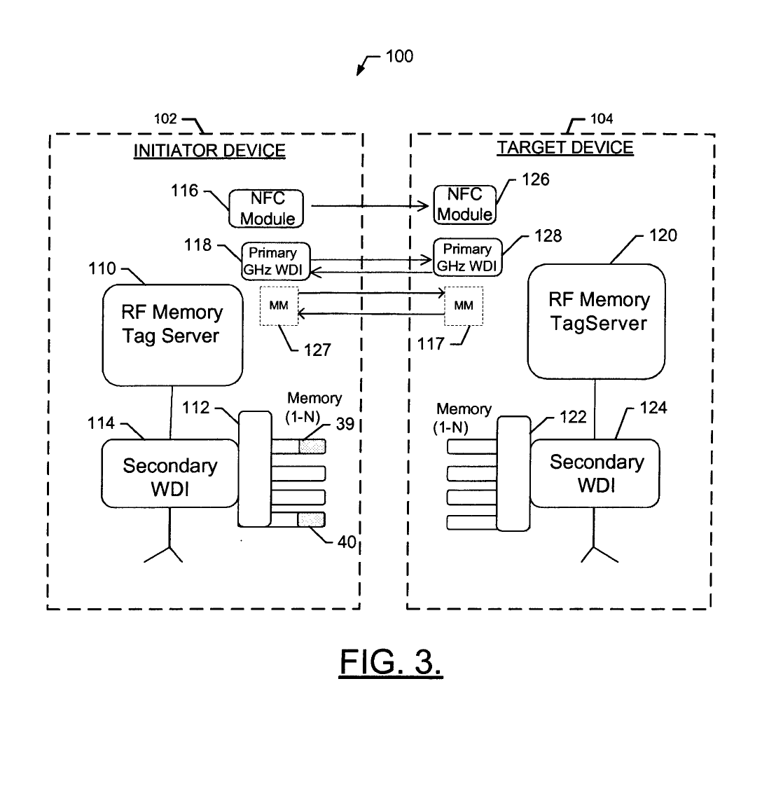

Referring now to FIG. 3, a diagram illustrating a direct memory copy between devices according to an example embodiment is provided. The system 100 may include an initiator device 102 (e.g., an apparatus 50) and a target device 104 (e.g., an apparatus 50). In this example embodiment, the initiator device 102 may perform a direct memory copy of data to be provided to or made accessible to the target device 104. However, in some alternative example embodiments, the target devices (e.g., target device 104) described herein may perform a direct memory copy of data to be provided to or made accessible to the initiator devices (e.g., initiator device 102) described herein. The initiator device 102 may include a NFC module 116 (e.g., NFC module 71), a primary WDI 118 (e.g., primary WDI 51 (for example, an 8 GHz WDI)), a memory manager (MM) 127 (e.g., memory manager 73). The initiator device 102 may also include an RF tag memory server 110 (e.g., RF memory tag server 36), a secondary WDI 114 (e.g., secondary WDI 41 (for example, a 60 GHz WDI)) and a memory 112 (e.g., memory 47). The target device 104 may include a NFC module 126 (e.g., NFC module 71), a primary WDI 128 (e.g., primary WDI 51), a memory manager (MM) 117 (e.g., memory manager 73). The target device 104 may include an RF tag memory server 120 (e.g., RF memory tag server 36), a secondary WDI 124 (e.g., secondary GHz WDI 41) and a memory 122 (e.g., memory 47).

In an instance in which the initiator device 102 and target device 104 are within a proximity (e.g., within 10 cm, etc.) of each other, the NFC module 116 of the initiator device 102 may wakeup (e.g., power up) and may exchange information such as, for example, continuous (CW) clock reference information as well as any other suitable information with the NFC module 126 of the target device 104 during an interrogation phase. The primary WDI 118 may communicate with the primary WDI 128 of the target device 104 to negotiate the data detected by the primary WDI 118 of the initiator device 102 that are available for remote access or data transfer to the target device 104. In an example embodiment, a user of initiator device 102 may, but need not, designate or specify that data is available for remote access. In another example embodiment, an application (e.g., a memory application executed by memory controller 54) may, but need not, designate or specify that data is available for remote access. In this regard, a memory controller (e.g., memory controller 54) of the primary WDI 118 may determine the available memory blocks for remote access by analyzing the memory 112. The memory controller (e.g., memory controller 54) of the primary WDI 118 may determine the available memory blocks in an instance in which the initiator device 102 and the target device 104 are close to each other such as, for example, within a predetermined proximity. The memory controller of the primary WDI 118 may also determine that there are overlapping memory areas between the initiator device 102 and the target device 104 when the devices 102, 104 are within the proximity. In this regard, the memory controller of the primary WDI 118 may determine that there are overlapping memory areas in an instance in which the memory controller determines that the memory 122 of the target device 104 has adequate memory available to store the data of the available memory blocks identified by the memory controller (e.g., memory controller 54) of the primary WDI 118 and when the primary WDI 118 determines that the target device has a secondary WDI (e.g., secondary WDI 124) available for reception of the data. In an example embodiment, a memory controller (e.g., memory controller 54) of the secondary WDI 128 of the target device 104 may provide data to the memory controller of the primary WDI 118 indicating whether it has adequate memory available for storing the data to be transferred and whether it has a secondary WDI (e.g., a 60 GHz WDI) available to receive the data.

In this example embodiment, the memory controller of the primary WDI 118 may determine that the memory blocks 39 and 40 are available for remote access and for direct copying or transfer to one or more memory blocks of the memory 122 of target device 104. The memory controller of the primary WDI 118 may provide this information to the primary WDI 128 during the negotiation and may specify to the primary WDI 128, an indication of the visibility of the available memory blocks. In this regard, the indication may include data specifying that the available memory blocks are part of the memory 112 of the secondary WDI 114.

The processor 44 of the RF memory tag server 110 may provide a token(s) to the secondary WDI 114 of the initiator device 102 indicating and allowing access to the memory blocks 39 and 40 by the secondary WDI 114 to enable the secondary WDI 114 to transfer the data of the memory blocks 39 and 40 to one or more memory blocks (e.g., blocks 1-N) of the memory 122 of the target device 104.

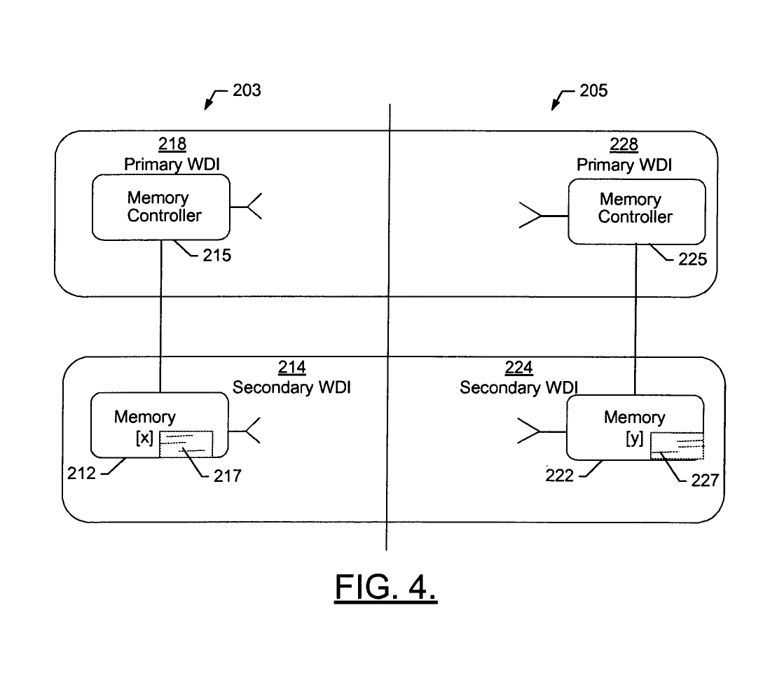

Referring now to FIG. 4, a diagram illustrating a system enabling memory access among devices according to an example embodiment is provided. The system may include a device 203 (e.g., an apparatus 50) and a device 205 (e.g., an apparatus 50). The memory controller 215 (e.g., memory controller 54) of the primary WDI 218 (e.g., primary WDI 51 (e.g., an 8 GHz primary WDI)) may access the memory 212 (e.g., memory 47) via an RF memory tag server (not shown) of a memory manager (not shown) and via the secondary WDI 214 (e.g., secondary GHz WDI 41 (e.g., a 60 GHz WDI)).

In addition, the memory controller 225 (e.g., memory controller 54) of the primary WDI 228 (e.g., primary WDI 51) may access the memory 222 (e.g., memory 47) via an RF memory tag server (not shown) of a memory manager (not shown) and via the secondary WDI 224 (e.g., secondary WDI 41).

The memory controller 215 may analyze the memory 212 and the memory controller 225 may analyze the memory 222 and may determine whether the memories 212, 222 have one or more memory blocks or areas with data available for remote access. In response to determining that there are one more blocks or areas of memory available for access, the memory controllers 215, 225 may, but need not, generate one or more pointers to the corresponding blocks or areas of memory and may identify the addresses of the blocks or areas of memory. The data associated with the pointers and/or the addresses may be stored in a memory (e.g., memory 52) by the memory controllers 215, 225. During negotiation of data for direct memory copy, the memory controllers 215, 225 may indicate the amount of data that is accessible for transfer. Alternatively, in an instance in which the memory controllers 215, 225 may negotiate to receive data for direct memory copy, the memory controllers 215, 225 may request the addresses and/or the pointers corresponding to the data that is available for transfer. In some example embodiments, the memory controllers 215, 225 may negotiate that only one memory controller (e.g., memory controller 215) performs the request for the addresses and/or pointers corresponding to the data.

In response to analyzing the memory 212, the memory controller 215 may identify one or more memory blocks 217 having content for direct memory copy to another device (e.g., memory 222). Similarly, in response to analyzing the memory 222, the memory controller 225 may identify one or memory blocks 227 having content for direct memory copy to another device (e.g., memory 212).

The memory controllers 215, 225 may negotiate the pointers for direct memory copy. For purposes of illustration and not of limitation, the memory controller 215 may negotiate with the memory controller 225 for transfer of data located at a memory block(s) associated with a pointer(s) and/or address(es). Additionally, the memory controllers 215, 225 may specify the manner in which to segment or divide one or more memory blocks, that are determined to be available for remote access, from different areas. For purposes of illustration and not of limitation, the memory controller 215 of device 203 may segment one or more memory blocks from a first area of memory 212 for transfer to another memory block or area of memory 222 of device 205. In this regard, the memory controller 215 may negotiate with the memory controller 225 regarding the manner in which to divide the content of the memory blocks during a memory access (also referred to herein as low level memory access (LLMA)) in which the data may be transferred via the secondary WDI 214 to the secondary WDI 224 for inclusion in the memory 222.

For instance, in this example embodiment, in response to analyzing the memory 212, the memory controller 215 may determine that the memory 212 has one or more memory blocks 217 available for remote access and for direct memory copy (e.g., transfer) to the memory 222. Similarly, in this example embodiment, in response to analyzing the memory 222, the memory controller 225 may determine that the memory 222 has one or more memory blocks 227 available for remote access and for direct memory copy (e.g., transfer) to the memory 212.

As another example, the memory controller 215 may inform the memory controller 225 from which physical memory area(s) one or more memory blocks may be read via a low level memory access path via the secondary WDI 214. In response, the memory controller 225 may request the memory 222 to read the data from that received physical memory area(s) directly to obtain and store the data in one or more memory block areas of memory 222.

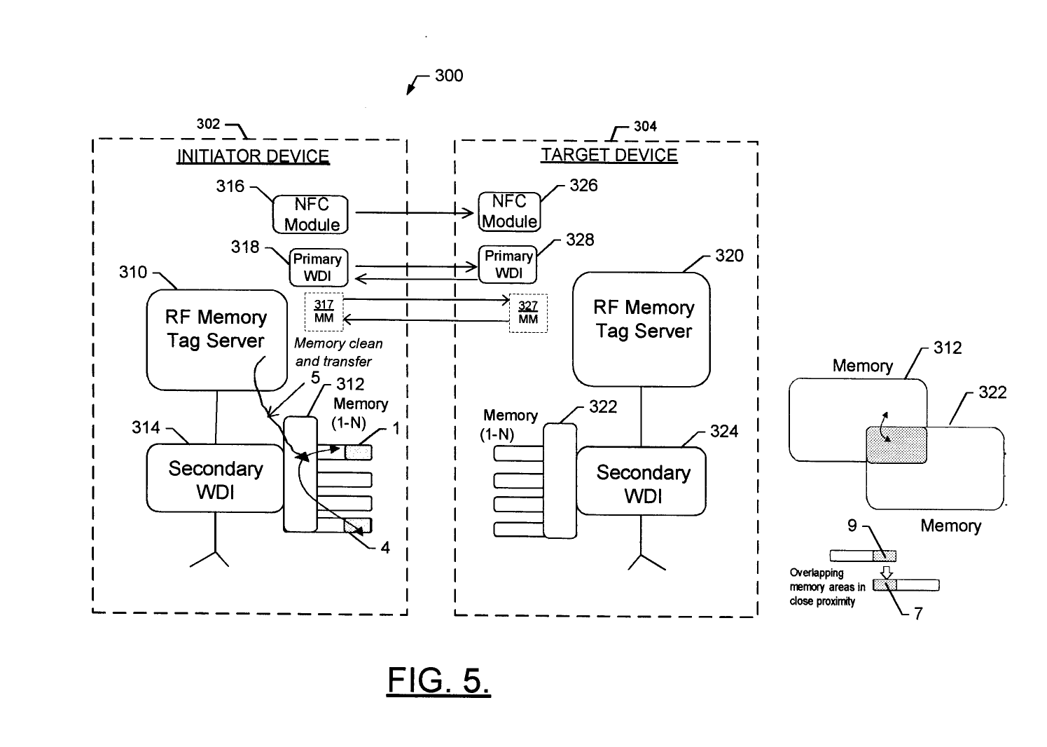

Referring now to FIG. 5, a diagram illustrating a system for enabling a direct memory copy between devices according to an example embodiment is provided. The system may include an initiator device 302 (e.g., apparatus 50) and a target device 304 (e.g., apparatus 50). In the example embodiment of FIG. 5, the initiator device 302 may negotiate with the target device 304 for direct memory of copy of data from the initiator device 302 to the target device 304, as described more fully below. The initiator device 302 may include a NFC module 316 (e.g., NFC module 71), a primary WDI 318 (e.g., a primary WDI 51 (e.g., an 8 GHz WDI)), and a memory manager 317 (e.g., memory manager 73). The device 302 may include a RF memory tag server 310 (e.g., RF memory tag server 36), a secondary WDI 314 (e.g., secondary GHz WDI 41) and a memory 312 (e.g., memory 47). The target device 304 may include a NFC module 326 (e.g., NFC module 71), a primary WDI 328 (e.g., primary GHz WDI 51), and a memory manager 327 (e.g., memory manager 73). The target device 304 may include a RF memory tag server 320 (e.g., RF memory tag server 36), a secondary WDI 324 (e.g., secondary WDI 41 (e.g., a 60 GHz WDI)) and a memory 322 (e.g., memory 47).

In an instance in which the NFC module 316 detects that the initiator device 302 is within a proximity of the target device 304, the NFC module 316 may wakeup and trigger an interrogation phase with the NFC module 326. During the interrogation phase, the NFC module 316 may send a continuous wave signal to the NFC module 326 in which the continuous wave signal may include clock reference information of the initiator device 302. Upon completion of the interrogation phase, a memory controller (e.g., memory controller 54) of the primary WDI 318 may analyze the memory 312 of a tag (e.g., tag 27 (e.g. a RF memory tag)) and may determine whether the memory 312 has one or more memory blocks with data that are available for direct memory copy to the memory 322 of a tag (e.g., tag 27) of the target device 304. When the initiator device 302 and target device 304 are within a given proximity of each other, the primary WDI 318 may initiate a negotiation regarding available data of one or more memory blocks for transfer. For instance, in response to determining that the memory 312 has one or more blocks of memory with data available for transfer, the memory controller of the primary WDI 318 may negotiate with the primary WDI 328 and may send information to the primary WDI 328 indicating the data and the block(s) of memory available for transfer. In response to the primary WDI 318 receiving an indication that the primary WDI 328 desires to receive the data of the memory blocks, the memory controller of primary WDI 318 may complete the negotiation for set up of the data transfer. In this regard, the memory controller of the primary WDI 318 may send a message to the RF tag memory server 310 indicating that the negotiation is complete pertaining to the setup. In an alternative example embodiment, in an instance in which the primary WDI 328 sends the primary WDI 318 a message indicating that the primary WDI 328 would not like to receive the data of the memory blocks, the memory controller of the primary WDI 318 may end the negotiation and the data of the memory blocks may not be transferred to the target device 304.

In response to receipt of an indication that the negotiation between the primary WDI 318 and the primary WDI 328 is complete and that the primary WDI 328 sends a request to receive the available data of one or more memory blocks of the memory 312, the RF memory tag server 310 may negotiate at which frequency (e.g., 60 GHz), which memory blocks are available for remote access. In this regard, the processor (e.g., processor 44) of the RF memory tag server 310 may manage with a file system, for example, the manner in which the local blocks of memory are controlled. The RF memory tag server 310 may, but need not, direct that all or part of the corresponding data of the memory blocks is transformed to one local memory block 1 or from one local memory block 1 to another local memory block 4 during a memory cleanup technique 5. The RF memory tag server 310 may control the memory cleanup and may clean all the memory blocks 1 to 4 of the memory 312. In an example embodiment, the memory cleanup may be performed by the RF memory tag server 310 by moving the data of a memory block to another memory block and deleting the data from the memory block in which the data was originally moved as well as by performing any other suitable mechanisms of transferring data among memory blocks.

In some example embodiments, the RF memory tag server 310 may perform one or more local memory operations such as, for example, one or more memory cleanups and/or content organization at a local memory (e.g., memory 312) before registration. As referred to herein, before registration may denote before direct copy of overlapping memory areas is allowed.

In this example embodiment, when the initiator device 302 and the target device 304 are within a predefined proximity to each other, the RF memory tag server 310 may determine whether one or more memory blocks/areas of the memories 312 and 322 are overlapping to enable the transfer or direct copying of the data of the available blocks of memory from the memory 312 to the memory 322. The RF memory tag server 310 may determine whether one or more memory blocks are overlapping during registration in an instance in which the RF memory tag server 310 determines that direct copy of overlapping memory areas is allowed. The RF memory tag server 310 may determine that one or more memory blocks/areas are overlapping in an instance in which the RF memory tag server 310 determines that the memory (e.g., memory 322) in which the available data is to be transferred has sufficient space and capacity to store the full block of data in the memory (e.g., memory 322) and upon detection that a target device (e.g., target device 304) has a secondary WDI (e.g., secondary WDI 324) available to facilitate the reception of the data for storage in the memory (e.g., memory 322). In an example embodiment, the RF memory tag server 310 may determine whether the memory 322 has space and capacity to store the available data of the blocks and whether target device has a secondary WDI (e.g., secondary WDI 324) available for facilitating reception of the data by analyzing information obtained from the secondary WDI 318 during the negotiation with the secondary WDI 328 of the target device 304.

In the example embodiment of FIG. 5, the RF memory tag server 310 may determine that at least two memory blocks are overlapping. For example, the RF memory tag server 310 may determine that the memory 322 has at least one memory block 7 with the capacity and space to store the data of at least one memory block 9 of memory 312 and that the secondary WDI 324 is detected and available to facilitate the receipt of the data to memory 322.

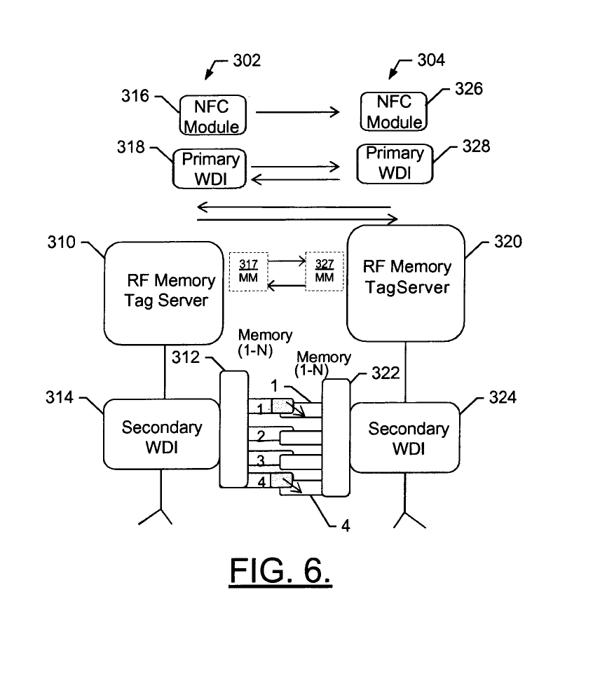

Referring now to FIG. 6, a diagram illustrating a system facilitating direct copy of data among devices according to an example embodiment is provided. In the example embodiment of FIG. 6, presume that the RF tag memory server 310 determined that the memory 312 of a tag (e.g., tag 27 (e.g., an RF memory tag)) has data (e.g., an image, audio data, etc.) available in one or more blocks such as, for example, blocks 1 and 4 for remote access and transfer to the memory 322 of another tag (e.g., another tag 27). Consider further, for example, that the RF memory tag server 310 determined that the memory 322 has capacity and space for the data at corresponding blocks 1 and 4 of the memory 322 and that the secondary WDI 324 is available for reception of the data based at least in part on the negotiation information provided by primary GHz WDI 318 to the RF memory tag server 310. In this regard, during registration, the RF memory tag server 310 may instruct the secondary WDI 314 to transfer or provide the data of the memory blocks 1 and 4 to the secondary WDI 324 for inclusion in the corresponding memory blocks 1, 4 of memory 322. As such, the processor (e.g., processor 43) of the secondary WDI 314 may facilitate the transfer of the data of the memory blocks 1 and 4 in an instance in which the initiator device 302 and the target device 304 are within a predefined proximity of each other. In this regard, the processor of the secondary WDI 314 may provide the data of the memory blocks 1 and 4 to the secondary WDI 324 and the secondary WDI 324 may provide the data (e.g., image data, audio data, etc.) to the memory blocks 1 and 4 of memory 322.

In this manner, the secondary WDI 314 may wirelessly bond memory blocks 1 and 4 of memory 312 to corresponding memory blocks 1 and 4 of memory 322. By wirelessly bonding the memory blocks 1 and 4 of memory 312 with the corresponding memory blocks 1 and 4 of memory 322, the secondary WDI 314 may integrate these areas of the memories 312 and 322, as shown in FIG. 6. In response to the RF memory tag server 310 determining that the transfer of the data of the memory blocks 1 and 4 to the target device 304 is complete, the RF memory tag server 310 may send a message to the secondary WDI 324 indicating the completion of the data transfer. It should be pointed out that in the example embodiment of FIG. 6, the processor of the secondary WDI 314 may provide the data from addresses (e.g., address A for memory block 1, address B for memory block 4) or pointers corresponding to the memory blocks 1 and 4 of the memory 312 to the secondary WDI 324 to facilitate the data transfer to the memory 322. Additionally, the secondary WDI 324 may transfer the data to memory 322 bit by bit or according to any other suitable manner of data transfer. It should also be pointed out that in the example embodiment of FIG. 6, the devices 302 and 304 are within a close proximity such that the primary WDI 318 and the secondary WDI 328 are close enough to perform the actions associated with integrating, at least partially, overlapping memory blocks (e.g., memory blocks 1 and 4), via the secondary WDI 314.

In an alternative example embodiment, another communication device (e.g., an apparatus 50, a second communication device 20, etc.) may instruct devices 302 and 304 to facilitate a direct memory copy between the devices 302 and 304. In this alternative example embodiment, the communication device may facilitate copying of data from a tag (e.g., tag 27 (e.g., a RF memory tag)) to another tag (e.g., tag 27). In this regard, the communication device may be an initiator/controller device in this alternative example embodiment.

Additionally, in an alternative example embodiment, the primary WDI 318 may provide or facilitate the direct memory copy with the primary WDI 328 instead of the secondary WDI 314 and the secondary WDI 324. In this regard, frequency negotiation may not be needed and as such preregistration (e.g., memory pointer negotiations) for transfer of one or more blocks or memory (e.g., memory 312) may be performed or executed by the primary WDI 318 and the primary WDI 328. The information associated with the preregistration may specify where the block(s) of memory starts and where the block(s) is to be transferred to (e.g., memory 322) within the same frequency (e.g., 8 GHz). In an instance in which the primary WDI 318 facilitates the transfer of the block(s) of memory to the primary WDI 328, the primary WDI 328 may send an acknowledgement to the primary WDI 318 acknowledging successful receipt of the transferred data associated with the block(s) of memory (e.g., memory 312).

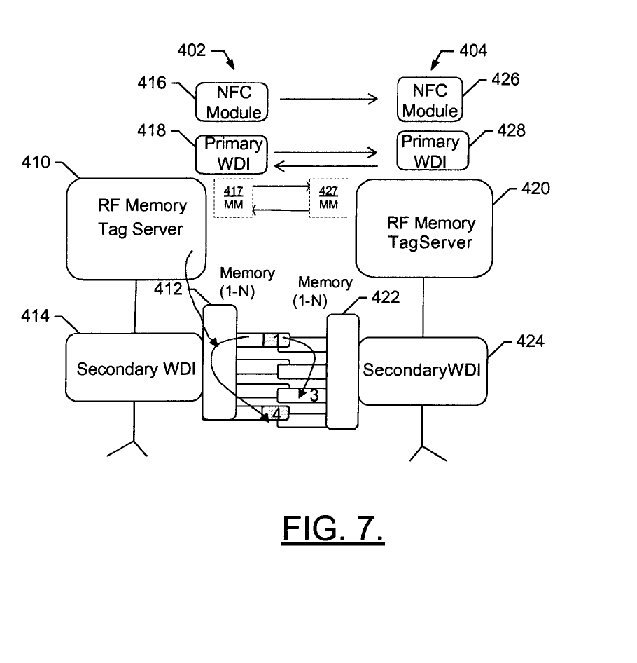

Referring now to FIG. 7, a diagram illustrating a system enabling direct copy of data among devices according to an example embodiment is provided. The system of FIG. 7 may include an initiator device 402 and a target device 404. The initiator device 402 may include an NFC module 416 (e.g., NFC module 71), an primary WDI 418 (e.g., primary WDI 51 (e.g., an 8 GHz WDI)) and a memory manager 417 (e.g., memory manager 73). The device 402 may include a RF memory tag server 410 (e.g., RF memory tag server 36), a secondary WDI 414 (e.g., secondary WDI 41 (e.g., a 60 GHz WDI)) and a memory 412 (e.g., memory 47). The target device 402 may include an NFC module 426 (e.g., NFC module 71), an primary WDI 428 (e.g., primary WDI 51) and a memory manager 427 (e.g., memory manager 73). The device 404 may include a RF memory tag server 420 (e.g., RF memory tag server 36), a secondary WDI 424 (e.g., secondary WDI 41) and a memory 422 (e.g., memory 47).

In the example embodiment of FIG. 7, consider for example, upon the completion of an interrogation phase by the NFC module 416 with the NFC module 426, that the memory controller of the primary WDI 418 analyzed the memory 412 and determined that data of memory blocks 1 and 4 are available for remote access. In this regard, the primary WDI 418 may negotiate with the primary WDI 428 for transfer of the data of the memory blocks 1 and 4 to one more corresponding memory blocks/areas of the memory 422 of a tag (e.g., tag 27 (e.g., a RF memory tag, etc.)) when the initiator device 402 and the target device 404 are within a predetermined proximity of each other. The processor of the primary WDI 418 may indicate the size of the data and may specify the location (e.g., one or more addresses and/or pointers) where data of memory blocks 1 and 4 are accessible to the primary WDI 428. In this example embodiment, the processor of the primary WDI 428 may send an indication to the primary WDI 418 indicating that it desires to receive the data and may specify that the data of memory blocks 1 and 4 may be received or transferred to memory block 3 of the memory 422 and may specify that the memory block 3 has the capacity/space to store the data. Additionally, the primary WDI 428 may send a message to the primary WDI 418 informing the primary WDI 418 that the secondary WDI 424 is available for the reception of the data for transferring to memory block 3 of memory 422.

As such, the secondary WDI 414 may transfer the data of blocks 1 and 4 of memory 412 to the secondary WDI 424 which may provide the data to memory block 3 of memory 422. The RF memory tag server 410 may send a message to the secondary WDI 424 (for example, via the memory manager (MM) 417 in one example embodiment) indicating that the data transfer of memory blocks 1 and 4 of memory 412 is complete. In response, the processor of the secondary WDI 424 may send a message to the RF memory tag server 410 acknowledging successful receipt of the data. In an alternative example embodiment, the secondary WDI 414 may combine block 1 and block 4 of the memory 412 and may negotiate with device 404 for a low level memory access (LLMA) transfer of integrated block 4 of memory 412 to block 3 of the memory 422 of device 402. Additionally, in an example embodiment, the memory transfer with LLMA may be partially completed. In this regard, the secondary WDI 414, may set a mark (e.g., within the RF memory tag server 36 and/or memory controllers (e.g., memory controller 54)), that, for example, a block 1 of memory 412 was transferred but that transfer of block 4 is still pending and is waiting for the free memory area of memory 422 to become available. The RF memory tag servers 110 and 120 may negotiate regarding the manner in which to deal with this partially transferred block of memory (e.g., memory block 4. For example, an RF memory tag server (e.g., RF memory tag server 120) may free some memory blocks in the future, transfer block 4 to some other memory or set a timer that additional transfers should occur between the devices 402 and 404 within a certain time period.

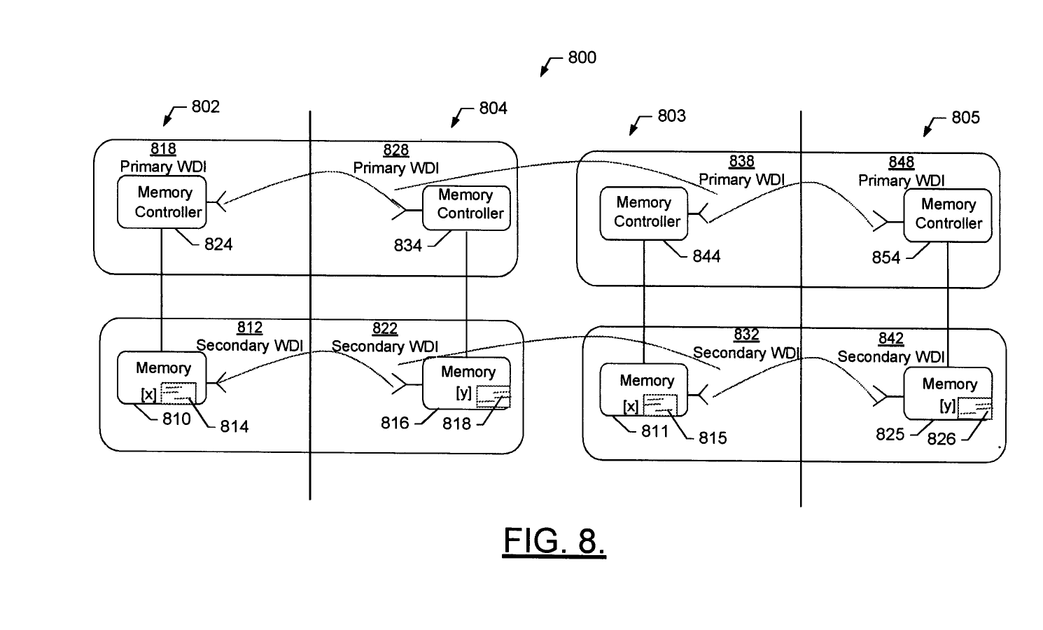

Referring now to FIG. 8, a diagram illustrating a system of chained memory controllers and chained memories for facilitating memory transfer between devices according to an example embodiment is provided. The system 800 may include a device 802 (e.g., device 203 (e.g., apparatus 50)), a device 803 (e.g., device 203), a device 804 (e.g., device 205 (e.g., apparatus 50)) and a device 805 (e.g., device 205). Although FIG. 8 shows that the system 800 includes four devices such as device 802, device 803, device 804 and device 805 it should be pointed out that the system may include any suitable number of devices without departing from the spirit and scope of the invention.

In an instance in which the device 802 enters within a proximity of the devices 803, 804 and 805, the memory controller 824 of the primary WDI 818 (e.g., an 8 GHz WDI) may be linked or connected to (also referred to herein as chained) to the memory controller 834 of the primary WDI 828 (e.g., an 8 GHz WDI), the memory controller 844 of the primary WDI 838 (e.g., an 8 GHz WDI) and/or the memory controller 854 of the primary WDI 848 (e.g., an 8 GHz WDI). In this regard, the memory controller 824 of the primary WDI 818 may negotiate with the primary WDI 828, the primary WDI 838 and/or the primary WDI 848 for direct transfer of data available via one or more memory blocks 814 of the memory 810. Presume in this example embodiment that the memory controllers 834, 844 and 854 may send a message to the memory controller 824 of the primary WDI 818 requesting transfer of the available data of the memory block(s) of memory 810 to one or more blocks 818, 815, and 826 of their respective memories 816, 811 and 825. In this regard, the memories 810, 816, 811 and 825 may be linked or chained together by the memory controller 824. In some example embodiments, a memory controller (e.g., memory controller 824) or chain origin device (not shown) and one or more target controllers (not shown) may handle the negotiation and one or more intermediate controllers (e.g., memory controller 834) may be bypassed, or the linking of the memories may be generated one chain at a time.

In an instance in which a processor (e.g., processor 43) of the secondary WDI 812 (e.g., a 60 GHz WDI) receives an instruction from an RF memory tag server (e.g., RF memory tag server 36) to transfer the data of one or more memory blocks 814, the secondary WDI 812 may facilitate transfer of the data to the secondary WDI 822 (e.g., a 60 GHz WDI), the a secondary WDI 832 (e.g., 60 GHz WDI), and/or the a secondary WDI 842 (e.g., a 60 GHz WDI) to enable the secondary WDI 822, the secondary WDI 832 and/or the secondary WDI 842 to provide the data to respective memories 816, 811 and/or 825. In an example embodiment, the chained direct memory copy performed by the secondary WDI 812 for transferring the data of one or more blocks 814 to the memories 816, 811 and/or 825 may conform to a Universal File Storage (UFS) system. As such, the secondary WDI 812, the secondary WDI 822, the secondary WDI 832 and the secondary WDI 842 may be linked to each other and wirelessly bonded via one or more UFS lines between the memories 810, 816, 811 and/or 825.

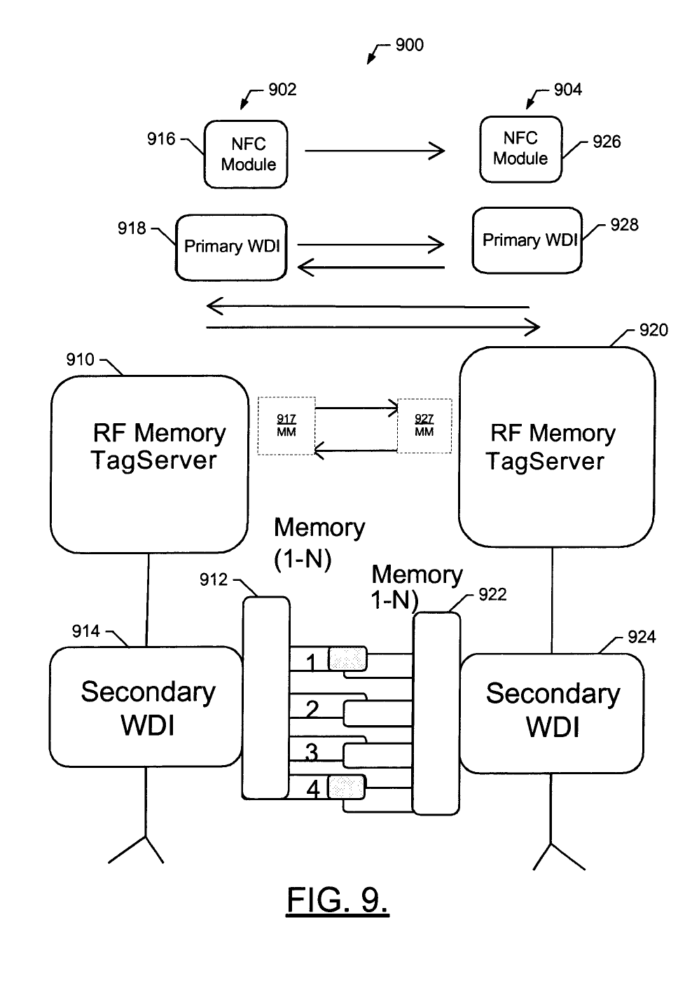

Referring now to FIG. 9, a system is provided for enabling exchange of additional parameters during a negotiation among devices according to an example embodiment. The system 900 of FIG. 9 may include an initiator device 902 and a target device 904. The initiator device 902 may include an NFC module 916 (e.g., NFC module 71), a primary WDI 918 (e.g., primary WDI 51 (e.g., an 8 GHz WDI)) and a memory manager (MM) 917 (e.g., memory manager 73). The device 902 may include a RF memory tag server 910 (e.g., RF memory tag server 36), a secondary WDI 914 (e.g., secondary WDI 41 (e.g., a 60 GHz WDI)) and a memory 912 (e.g., memory 47). The target device 504 may include an NFC module 926 (e.g., NFC module 71), a primary WDI 928 (e.g., primary WDI 51 (e.g., an 8 GHz WDI)) and a memory manager (MM) 927 (e.g., memory manager 73). The memory manager 927 may include a RF memory tag server 920 (e.g., RF memory tag server 36), a secondary WDI 924 (e.g., secondary WDI 41) and a memory 922 (e.g., memory 47).

In this example embodiment, in an instance in which the RF memory tag server 910 may negotiate with the RF memory tag server 920 (via the MM 917 and the MM 927 in an example embodiment), for example, for the frequency (e.g., 60 GHz) at which one or more memory blocks may be available for remote access, the RF memory tag server 910 may also send one or more parameters such as, for example, one or more power tokens and/or one or more memory tokens to the RF memory tag server 920 during the negotiation. In an example embodiment, the power token(s) may include data specifying that the initiator device 902 may power the memory 922 during the transfer of data to the target device 904 or for some other predefined time period or duration. In this regard, the target device 904 may conserve energy. This approach of powering the memory 922 may be beneficial in an instance in which the memory manager 927 is part of a passive tag (e.g., a passive RF tag, a passive NFC tag) in which the passive tag may not have its own power source.

As an example, in an instance in which the RF memory tag server 910 of the initiator device 902 provides a power token(s) to the RF tag memory server 920 of the target device 904, the RF memory tag server 910 may be able facilitate power to the memory area of the memory 922 and as such the target device 904 may shut down its peak power to the memory 922 and may save power.

Additionally, in an example embodiment, the memory token(s) may include data specifying the target device 904 to give the initiator device 902 some data (e.g., a file, etc.). As an example, in an instance in which the RF memory tag server 910 provides the memory token(s) to the RF memory tag server 920 during a negotiation, the RF memory tag server 920 may evaluate the data (e.g., a file) associated with the memory token(s) requesting the RF memory tag server 920 to facilitate transfer, via the secondary WDI 924, of requested data (e.g., a file, etc.) in one or more available memory blocks of memory 922 to the initiator device 902. In an example embodiment, the RF memory tag server 920 may instruct the secondary WDI 924 to transfer the requested data to the initiator device 902 in response to receipt of the data in one or more memory blocks of memory 912 which may be sent via the secondary WDI 914 to the target device 904.

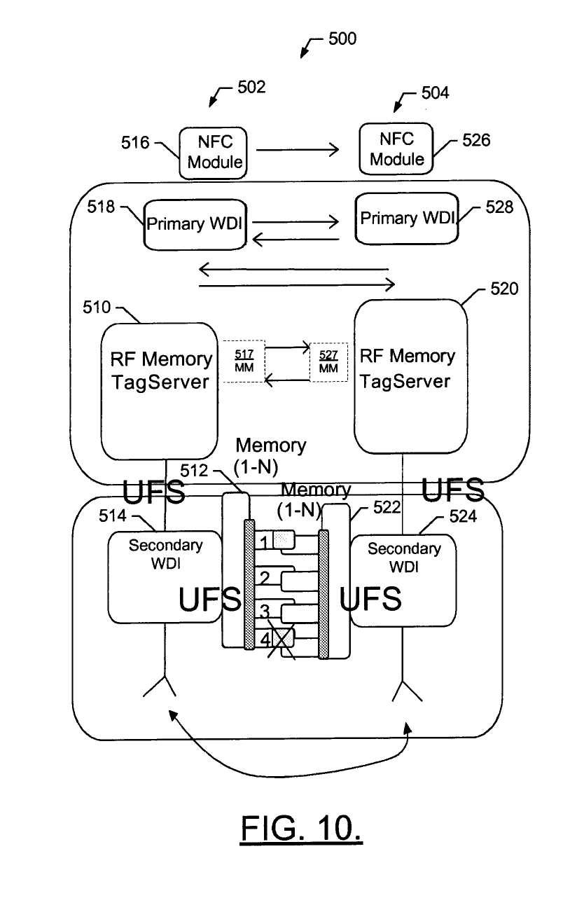

Referring now to FIG. 10, a system is provided for preserving privacy of data exchanged among devices according to an example embodiment. The system 500 of FIG. 10 may include an initiator device 502 and a target device 504. The initiator device 502 may include an NFC module 516 (e.g., NFC module 71), a primary WDI 518 (e.g., primary GHz WDI 51 (e.g., an 8 GHz WDI)) and a memory manager (MM) 517 (e.g., memory manager 73). The device 502 may include a RF memory tag server 510 (e.g., RF memory tag server 36), a secondary GHz WDI 514 (e.g., secondary GHz WDI 41 (e.g., a 60 GHz WDI)) and a memory 512 (e.g., memory 47). The target device 504 may include an NFC module 526 (e.g., NFC module 71), a primary WDI 528 (e.g., primary WDI 51) and a memory manager (MM) 527 (e.g., memory manager 73). The device 504 may include a RF memory tag server 520 (e.g., RF memory tag server 36), a secondary WDI 524 (e.g., secondary WDI 41) and a memory 522 (e.g., memory 47).

In this example embodiment, in an instance in which the RF memory tag server 510 may negotiate with the RF memory tag server 520, for example, for the frequency (e.g., 60 GHz) at which one or more memory blocks may be available for remote access, the RF memory tag server 510 may send one or more parameters such as, for example, one or more items of privacy data (also referred to herein as privacy enabler data) to the RF memory tag server 520. The privacy data may relate to one or more privacy rules, privacy instructions or the like restricting or prohibiting access to specified data of one or more memory blocks/areas during a direct memory copy, or any other time period, in which some content is provided from available memory blocks of the memory 512 to the memory 522.

For purposes of illustration and not of limitation, the RF memory tag server 510 may send a message including data to the RF memory tag server 520, during a negotiation, indicating that the data of memory block 1 is available for transfer at a specified frequency (e.g., 60 GHz) and may also include privacy data in the message indicating to the RF memory tag server 520 that data of memory block 4 of the memory 512 is restricted or prohibited from being copied or provided to the memory 522 of the target device 504. In this regard, the secondary WDI 524 of the target device 504 is unable or prohibited to access the data of memory block 4 during the receipt of data of memory block 1 of the memory 512.

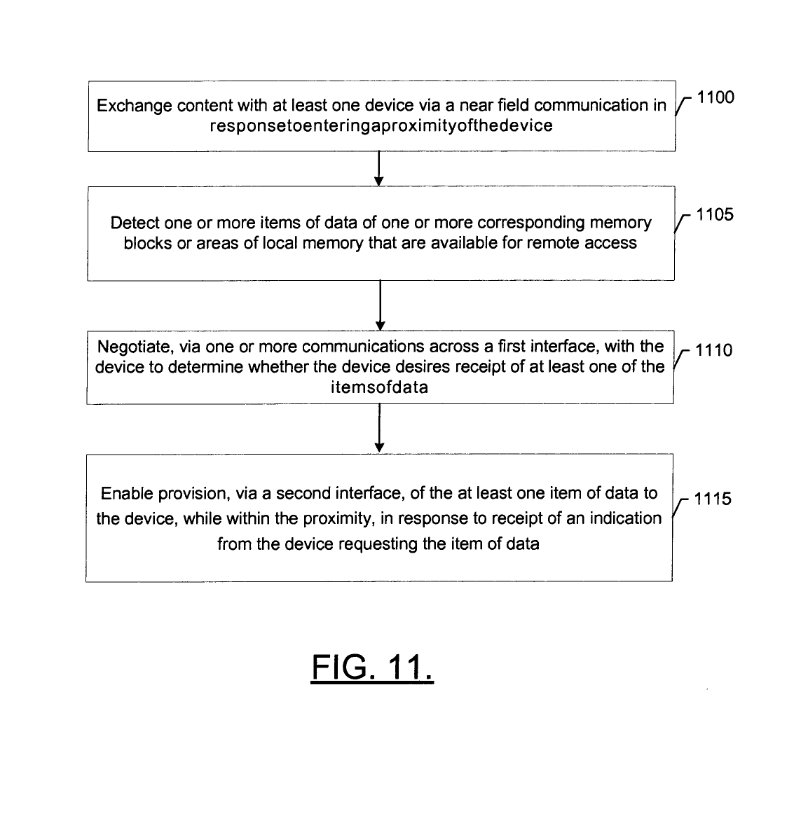

Referring now to FIG. 11, an example embodiment of a flowchart for providing an efficient and reliable manner of facilitating a direct memory copy is provided. At operation 1100, an apparatus (e.g., apparatus 50 (e.g., initiator device 102)) may exchange content with at least one device (e.g., target device 104) via a near field communication in response to entering a proximity of the device. At operation 1105, an apparatus (e.g., apparatus 50 (e.g., initiator device 102)) may detect one or more items of data of one or more corresponding memory blocks or areas of local memory (e.g., memory 47 (e.g., memory 112)) that are available for remote access. At operation 1110, an apparatus (e.g., apparatus 50 (e.g., initiator device 102)) may negotiate, via one or more communications across a first interface (e.g., a primary WDI 51 (e.g., primary WDI 118 (e.g., an 8 GHz WDI))), with the at least one device (e.g., target device 104). The negotiation with the at least one device may be to determine whether the device desires receipt of at least one of the items of data.

At operation 1115, an apparatus (e.g., apparatus 50 (e.g., initiator device 102)) may enable provision, via a second interface (e.g., secondary WDI 41 (e.g., secondary WDI 124 (e.g., a 60 GHz WDI))), of the at least one item of data to the device, while within the proximity of the device. The apparatus may enable the provision via the second interface in response to receipt of an indication from the device requesting the item of data in order to enable the device to store the item of data in one or more agreed upon memory blocks or areas of remote memory (e.g., memory 122 (e.g., memory 47)).

It should be pointed out that FIG. 11 is a flowchart of a system, method and computer program product according to some example embodiments of the invention. It will be understood that each block of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in some example embodiments, the computer program instructions which embody the procedures described above are stored by a memory device (for example, memory device 76, memory 52, memory 45, memory 47) and executed by a processor (for example, processor 70, memory controller 54, processor 44, processor 43). As will be appreciated, any such computer program instructions may be loaded onto a computer or other programmable apparatus (for example, hardware) to produce a machine, such that the instructions which execute on the computer or other programmable apparatus cause the functions specified in the flowchart blocks to be implemented. In some example embodiments, the computer program instructions are stored in a computer-readable memory that can direct a computer or other programmable apparatus to function in a particular manner, such that the instructions stored in the computer-readable memory produce an article of manufacture including instructions which implement the function(s) specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart blocks.

Accordingly, blocks of the flowchart support combinations of means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some example embodiments, an apparatus for performing the method of FIG. 11 above may comprise a processor (for example, the processor 70, the memory controller 54, the processor 44, the processor 43) configured to perform some or each of the operations (1100-1115) described above. The processor may, for example, be configured to perform the operations (1100-1115) by performing hardware implemented logical functions, executing stored instructions, or executing algorithms for performing each of the operations. Alternatively, the apparatus may comprise means for performing each of the operations described above. In this regard, according to some example embodiments, examples of means for performing operations (1100-1115) may comprise, for example, the processor 70 (for example, as means for performing any of the operations described above), the memory controller 54, the processor 44, the processor 43, and/or a device or circuitry for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-23. (canceled)

24. A method comprising:
exchanging content with at least one device via a near field communication in response to entering a proximity of the device;
detecting one or more items of data of one or more corresponding memory blocks or areas of local memory that are available for remote access;
negotiating, via one or more communications across a first interface, with the at least one device to determine whether the device desires receipt of at least one of the items of data; and
enabling provision, via a second interface, of the at least one item of data to the device, while within the proximity, in response to receipt of an indication from the device requesting the item of data in order to enable the device to store the item of data in one or more agreed upon memory blocks or areas of remote memory.

25. The method of claim 24, wherein prior to enabling provision, the method further comprises:
determining, during the negotiating, that one of the blocks or areas of the remote memory of the device comprises capacity to store the item of data and that the device comprises a dedicated interface that is available for reception of the item of data, wherein the dedicated interface is designated to communicate with the second interface.

26. The method of claim 24, wherein detecting the items of data comprises analyzing the local memory and determining an amount of the data available for remote access and one or more corresponding addresses or pointers in which respective items of the data are located or accessible.

27. The method of claim 24, wherein the negotiating further comprises assigning the item of data of at least one of the blocks or areas of the local memory for transfer to at least one of the agreed upon blocks or areas of the remote memory and designating a frequency at which the item of data is available for the transfer.

28. The method of claim 24, wherein during the negotiating, receiving at least one of the communications from another interface of the device that is dedicated to the negotiating and dedicated to facilitating communications with the first interface.

29. The method of claim 24, further comprising:
receiving an indication specifying that the item of data was successfully received by the device.

30. The method of claim 24, further comprising:
communicating with a plurality of devices in response to entering a predetermined proximity of the devices;
establishing a link or chain among one or more respective controllers of the devices and one or more respective memories of the devices while within the predetermined proximity; and
enabling provision of at least one item of negotiated information of at least one of the blocks or areas of the local memory, that is determined available for remote access, to corresponding memory blocks or areas of the respective memories of the devices in response to receipt of a request by the devices for the negotiated item of information.

31. The method of claim 24, wherein during the negotiating, the method further comprises:
facilitating provision of one or more parameters to the device, the parameters specifying information indicating that an apparatus agrees to provide power to the local memory, at least for a duration during the provision of the item of data, or information requesting the device to provide the apparatus with one or more items of content of the remote memory to facilitate storage of the items of content in the local memory.

32. The method of claim 24, wherein during the negotiating, the method further comprises:
enabling provision of one or more parameters to the device, the parameters specifying information restricting access to at least one identified item of data, among the items of data, to prohibit the device from receiving or accessing the identified item.

33. An apparatus comprising:
at least one processor; and
at least one memory including computer program code configured to, with the at least one processor, cause the apparatus to perform at least the following:
exchange content with at least one device via a near field communication in response to entering a proximity of the device;
detect one or more items of data of one or more corresponding memory blocks or areas of local memory that are available for remote access;
negotiate, via one or more communications across a first interface, with the at least one device to determine whether the device desires receipt of at least one of the items of data; and
enable provision, via a second interface, of the at least one item of data to the device, while within the proximity, in response to receipt of an indication from the device requesting the item of data in order to enable the device to store the item of data in one or more agreed upon memory blocks or areas of remote memory.

34. The apparatus of claim 33, wherein prior to enable the provision, the memory and computer program code are configured to, with the processor, cause the apparatus to:
determine, during the negotiating, that one of the blocks or areas of the remote memory of the device comprises capacity to store the item of data and that the device comprises a dedicated interface that is available for reception of the item of data, wherein the dedicated interface is designated to communicate with the second interface.

35. The apparatus of claim 33, wherein the memory and computer program code are configured to, with the processor, cause the apparatus to:
detect the items of data by analyzing the local memory and determining an amount of the data available for remote access and one or more corresponding addresses or pointers in which respective items of the data are located or accessible.

36. The apparatus of claim 33, wherein the memory and computer program code are configured to, with the processor, cause the apparatus to:
negotiate with the device by assigning the item of data of at least one of the blocks or areas of the local memory for transfer to at least one of the agreed upon blocks or areas of the remote memory and designating a frequency at which the item of data is available for the transfer.

37. The apparatus of claim 33, wherein during the negotiating, the memory and computer program code are further configured to, with the processor, cause the apparatus to:
receive at least one of the communications from another interface of the device that is dedicated to the negotiating and dedicated to facilitating communications with the first interface.

38. The apparatus of claim 33, wherein the memory and computer program code are further configured to, with the processor, cause the apparatus to:
receive an indication specifying that the item of data was successfully received by the device.

39. The apparatus of claim 33, wherein the memory and computer program code are further configured to, with the processor, cause the apparatus to:
communicate with a plurality of devices in response to entering a predetermined proximity of the devices;
establish a link or chain among one or more respective controllers of the devices and one or more respective memories of the devices while within the predetermined proximity; and
enable provision of at least one item of negotiated information of at least one of the blocks or areas of the local memory, that is determined available for remote access, to corresponding memory blocks or areas of the respective memories of the devices in response to receipt of a request by the devices for the item of negotiated information.

40. The apparatus of claim 33, wherein during the negotiating, the memory and computer program code are configured to, with the processor, cause the apparatus to:
facilitate provision of one or more parameters to the device, the parameters specifying information indicating that the apparatus agrees to provide power to the local memory, at least for a duration during the provision of the item of data, or information requesting the device to provide the apparatus with one or more items of content of the remote memory to facilitate storage of the items of content in the local memory.

41. The apparatus of claim 33, wherein during the negotiating, the memory and computer program code are further configured to, with the processor, cause the apparatus to:
enable provision of one or more parameters to the device, the parameters specifying information restricting access to at least one identified item of data, among the items of data, to prohibit the device from receiving or accessing the identified item.

42. The apparatus of claim 33, wherein the remote memory is embedded within at least one of a first radio frequency memory tag, a first radio frequency tag or a first near field communication tag and the local memory is embedded within at least one of a second radio frequency memory tag, a second radio frequency tag or a second near field communication tag.

43. A computer program product comprising at least one tangible computer-readable storage medium having computer-readable program code portions stored therein, the computer-readable program code portions comprising:
program code instructions configured to facilitate exchange of content with at least one device via a near field communication in response to entering a proximity of the device;
program code instructions configured to detect one or more items of data of one or more corresponding memory blocks or areas of local memory that are available for remote access;
program code instructions configured to negotiate, via one or more communications across a first interface, with the at least one device to determine whether the device desires receipt of at least one of the items of data; and
program code instructions configured to enable provision, via a second interface, of the at least one item of data to the device, while within the proximity, in response to receipt of an indication from the device requesting the item of data in order to enable the device to store the item of data in one or more agreed upon memory blocks or areas of remote memory.
